(19) United States
(12) Patent Application Publication
(10) Pub. No.: US 2011/0009462 A1
(43) Pub. Date: Jan. 13, 2011

(54) STABLE, SYNERGISTIC MIXTURES

(75) Inventors: Hermann Uhr, Leverkusen (DE); Peter Wachtler, Krefeld (DE); Tanja Gerharz, Dusseldorf (DE); Martin Kugler, Leichlingen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/738,938

(22) PCT Filed: Oct. 28, 2008
(86) PCT No.: PCT/EP08/64095

§ 371 Date: Sep. 15, 2010

(30) Foreign Application Priority Data
Oct. 25, 2007 (DE) 10 2007 051 006.5

(51) Int. Cl. A01N 43/80; A01P 3/00; A01P 1/00

(52) U.S. Cl. 514/372

(57) ABSTRACT

The present invention relates to storage-stable, synergistically acting combinations comprising glutaraldehyde (GDA) and 2-methyl-2H-isothiazol-3-one (methylisothiazolinone, MIT) and, where appropriate, 2-bromo-2-nitropropane-1,3-diol (bronopol) and/or other active substances for protecting industrials materials.

The present invention relates to storage-stable synergistically-acting combinations comprising glutardialdehyde (GDA) and 2-methyl-2H-isothiazol-3-one (methylisothiazolinone, MIT) and, if appropriate, 2-bromo-2-nitropropane-1,3-diol (bronopol) and/or other active substances for the protection of industrial materials.

GDA has been known from as early as the 1960s as antimicrobially active compound (Gorman, S. P., Scott, E. M. and Russel, A. D., 1980: Antimicrobial activity, uses and mechanism of action of glutaraldehyde. J. Appl. Bacteriol. 48, 161-90.). Typically, GDA is employed as a 2 to 50% strength by weight solution whose pH has been brought to <7. At pH values above 7, GDA increasingly tends to polymerize, but also shows what is known as the “Fast Killing” effect, which is why GDA is frequently employed as disinfectant and sterilant or else as slimicide, and, somewhat more rarely, as preservative.

Another microbicide with outstanding antimicrobial properties is MIT. As a rule, MIT is combined with other rapidly-acting isothiazolinones such as, for example, 5-chloro-2-methyl-4-isothiazolin-3-one (chloromethylisothiazolinone, CMIT) or else with bronopol.

Microbicidal mixtures comprising GDA plus CMIT and MIT are already known and are employed for the preservation of industrial materials. Thus, DE 3313689 describes mixtures comprising GDA plus CMIT and MIT, which mixtures are used for the antimicrobial treatment of cooling-water systems and for process waters in papermaking.

KR 2000015319 A describes synergistic mixtures comprising GDA plus CMIT and MIT for use in papermaking and for the preservation of process waters.

JP 2002 370906 A describes mixtures comprising GDA and MIT in the ratio 1:1 and synergistic mixtures comprising GDA, MIT and o-phthalaldehyde.

However, the above prior-art mixtures share the feature that, owing to the formation of degradation products, their storage stability is very low, which greatly limits the industrial applicability, or that they do not fully show the desired activity.

It is known from JP 01272506 to employ CMIT and MIT mixtures for stabilization purposes in the form of a magnesium complex and, if appropriate, to add solvents such as, for example, ethylene glycol.

JP 03112908 describes stabilized microbicidal solutions comprising GDA plus CMIT and MIT in the form of a magnesium complex, and also polyglycols.

JP 05271015 describes mixtures comprising GDA plus clathrates of CMIT and MIT with 1,1,6,6-tetraphenyl-2,4-hexadyn-1,6-diol.

The abovementioned mixtures and solutions share the fact that their preparation is complicated.

There was therefore a need for providing microbicidal compositions which feature the advantageous effects of GDA and isothiazolinones while having improved storage stability.

There have now been found compositions comprising GDA, MIT and, if appropriate, CMIT, the CMIT content being from 0 to 4% based on the weight ratio of CMIT to MIT and the weight ratio of GDA to MIT being at least 1.1:1, preferably 1.5:1 to 50:1, especially preferably 2:1 to 20:1 and very especially preferably 4:1 to 20:1.

It has furthermore been found that the compositions according to the invention which comprise GDA and MIT have a pronounced synergistic effect, i.e. that MIT and GDA, when used concomitantly, can be used at lower concentrations in comparison with the concentrations required for the individual components.

Besides the mentioned ranges and preferred ranges of formulae and parameters, the scope of the invention also encompasses any combinations thereof, even if they are not explicitly mentioned in their entirety for the sake of practicality.

In comparison with the prior art, the compositions according to the invention are distinguished by the fact that they are highly effective and particularly storage-stable microbicidal compositions.

This has the further advantage that the skin-sensitizing potential, which can be attributed to CMIT, is very noticeably reduced.

The compositions according to the invention are outstandingly suitable as preservatives for industrial materials. The term “industrial materials” generally, but without limitation, comprises the following technical materials and products:
paints, colors, renders and other coating materials
starch solutions and starch slurries or other starch-based products such as, for example, printing gums
slurries of other raw materials such as color pigments (for example iron oxide pigments, carbon black pigments, titanium dioxide pigments) or slurries of inorganic fillers and pigments such as kaolin, calcium carbonate, gypsum, bentonite, magnesium silicates, smectite or talcum.

Products of construction chemistry, such as concrete additives, for example those based on molasses, lignosulfonate or polyacrylates, bitumen emulsions or joint sealants
glues or adhesives based on the known animal, vegetable or synthetic raw materials
polymer dispersions based on, for example, polyacrylate, polystyrene acrylate, styrene butadiene, polyvinyl acetate and the like
detergents and cleaners for industrial and domestic purposes
mineral oils and mineral oil products (such as, for example, diesel fuels)
cooling lubricants for metal working based on mineral-oil-comprising, semisynthetic or synthetic concentrates
adjuvants for the leather, textile or photochemical industry
precursors and intermediates of the chemical industry, for example in dye production and storage
inks or various types of tusche
wax and clay emulsions

Preferably, the industrial materials are:
starch solutions and starch slurries or other starch-based products such as, for example, printing gums
slurries of other raw materials such as color pigments (for example iron oxide pigments, carbon black pigments, titanium dioxide pigments) or slurries of inorganic fillers and pigments such as kaolin, calcium carbonate, gypsum, bentonite, magnesium silicates, smectite or talcum.

Especially preferably, the industrial materials are:
slurries of inorganic fillers and pigments such as kaolin, calcium carbonate, gypsum, bentonite, magnesium silicates, smectite or talcum.

The compositions according to the invention are used for the protection of industrial materials as described above; they are particularly effective against bacteria, yeasts and against slime organisms and, in the presence of a further fungicide, additionally also against molds.

The following microorganisms may be mentioned by way of example, but not by way of limitation:

Alternaria such as Alternaria tenuis, Aspergillus such as Aspergillus niger, Chaetomium such as Chaetomium globosum, Fusarium such as Fusarium solani, Lentinus such as Lentinus tigrinus, Penicillium such as Penicillium glaucum;

Alcaligenes such as Alcaligenes faecalis, Bacillus such as Bacillus subtilis, Escherichia such as Escherichia coli, Pseudomonas such as Pseudomonas aeruginosa or Pseudomonas fluorescens, Staphylococcus such as Staphylococcus aureus;

Candida such as Candida albicans, Geotrichum such as Geotrichum candidum, Rhodotorula such as Rhodotorula rubra.

In order to further improve the biocidal activity of the compositions according to the invention and to widen the spectrum of action, the compositions according to the invention may additionally also comprise one or more active substances which are selected from the following group:

bronopol, benzoisothiazolin-3-one, benzyl hemiformal, tetramethylolacetylenediurea (TMAD), 1,3-bis(hydroxymethyl)-5,5-dimethylimidazolidine-2,4-dione (DMDMH),

p-chloro-m-cresol, dimethylolurea-1,2-dibromo-2,4-dicyanobutane, 2,2-dibromo-3-nitrilopropionamide, ethylene glycol hemiformal, ethylene glycol bishemiformal, N-methylolurea, 2-phenoxyethanol, phenoxypropanol, o-phenylphenol, chlorophene, quaternary ammonium salts such as, for example, N-alkyl-N,N-dimethylbenzylammonium chloride, and trimethylene-2-methylisothiazolinon-3-one.

In a further embodiment of the invention, the compositions according to the invention additionally comprise one or more fungicides in order to achieve an additional fungicidal effect. Preferred fungicides are selected from the following group:

4,5-dichloro-2-n-octylisothiazolin-3-one, iodopropargyl butylcarbamate, 2-n octylisothiazolin-3-one, thiabendazole, carbendazim, zinc pyrithione and sodium pyrithione.

The use concentrations of the compositions according to the invention, and the ratio of GDA and MIT to the further active substances which are optionally present, depend on the nature and the abundance of the microorganisms to be controlled, on the initial microbial load, and on the composition of the material to be protected. The optimum application rate for a particular use can be determined in a simple manner by laboratory test series in a manner sufficiently well known to the skilled worker before the composition is employed in practice.

Usually, the industrial production of MIT always also gives rise to minor amounts of CMIT as a by-product, small amounts of CMIT can always be present in the combinations without, however, having any significant effect on the stability and activity of the combinations.

The compositions according to the invention can therefore comprise between 0 and 4% of CMIT, preferably from 0 to 2%, especially preferably from 0 to 1% and very especially preferably from 0 to 0.5% CMIT, based on the weight of the amount of MIT which is also present.

The total of GDA and MIT in concentrates or formulations can be varied within a broad range. In general, the total of GDA and MIT is from 1 to 80% by weight, preferably from 2 to 70% by weight and especially preferably from 5 to 60% by weight.

The compositions according to the invention are preferably aqueous and may additionally comprise polyhydric alcohols in order to further improve the storage stability. Polyhydric alcohols are glycols such as, for example, diethylene glycol, triethylene glycol, tetraethylene glycol, polyethylene glycols with a molecular weight of from 200 to 10 000, dipropylene glycol, tripropylene glycol or polypropylene glycol with a molecular weight of from 200 to 10 000.

The amount of further active substances which are optionally employed in the compositions according to the invention may vary within a wide range and depends greatly on the nature of the active substance and on the medium to be protected. In general, it may be between 0.2 and 30% by weight, preferably between 0.5 and 25% by weight and especially preferably between 1 and 20% by weight.

Furthermore, the invention also comprises the industrial materials treated with the compositions according to the invention.

In general, the industrial medium comprises, for preservation purposes, 2 to 2000 ppm of GDA and 0.5 to 500 ppm of MIT while maintaining the ratios described at the outset, preferably 5 to 1500 ppm of GDA and 1 to 300 ppm of MIT and especially preferably 10 to 1000 ppm of GDA and 2 to 200 ppm of MIT.

Furthermore, the invention comprises a method for antimicrobial equipment of industrial materials, which is characterized in that industrial materials are treated with a composition according to the invention.

In further aspects, the invention comprises the use of GDA and MIT for the preparation of the compositions according to the invention, and to the use of the compositions according to the invention for the protection of industrial materials.

In comparison with the prior art, the compositions according to the invention are distinguished by the fact that they are highly active and particularly storage-stable as microbicidal compositions.

### EXAMPLES

### 1 Biological Examples

The synergism was determined by the method described by Kull et al. (F. C. Kull, P. C. Eismann, H. D. Sylvestrowicz, R. L. Mayer, Applied Microbiology 9, 538 to 541, 1961). The following relationships apply:

$$Qa \times \frac{MIC ( A + B )}{MIC ( A )} ⊕ Qb \times \frac{MIC ( A + B )}{MIC ( B )} = SI$$

Qa=amount of substance A
Qb=amount of substance B
MIC(A)=concentration of substance A which prevents microbial growth
MIC(B)=concentration of substance B which prevents microbial growth
MIC(A+B)=concentration of substance A+B which prevents microbial growth
SI=synergistic index, where SI=1 means additive effect
   SI>1 means antagonism
   SI<1 means synergism

### Example 1

Various concentrations of GDA and MIT and mixtures of the two abovementioned active substances were tested against the bacterium Pseudomonas fluorescens. The incubation is performed in Landy minimal medium at pH 7 and 26° C. The growth of Pseudomonas fluorescens was compared at various active substance concentrations with the growth without active substance. The lowest concentration at which growth was no longer detected is stated as the minimum inhibitory concentration (MIC).

| Active | | | |
|---|---|---|---|
| substance | Mixing ratio | MIC [ppm] | SI |
| GDA | | 20 | |
| GDA:MIT | 1:1 (for comparison) | 5 | 0.63 |
| GDA:MIT | 3:2 | 5 | 0.55 |
| GDA:MIT | 4:1 | 10 | 0.40 |
| MIT | | 5 | |

The index data determined demonstrate that the combination according to the invention of GDA and MIT shows particularly pronounced synergism.

### Example 2

Various concentrations of GDA and MIT and mixtures of the two abovementioned active substances were tested against the bacterium Pseudomonas fluorescens. The incubation is performed in Landy minimal medium at pH 9 and 26° C. The growth of Pseudomonas fluorescens was compared at the various active substance concentrations with the growth without active substance. The lowest concentration at which growth was no longer detected is stated as the minimum inhibitory concentration (MIC).

| Active | | | |
|---|---|---|---|
| substance | Mixing ratio | MIC [ppm] | SI |
| GDA | | 50 | |
| GDA:MIT | 1:1 (for comparison) | 5 | 0.18 |
| GDA:MIT | 3:2 | 5 | 0.16 |
| GDA:MIT | 4:1 | 10 | 0.13 |
| MIT | | 20 | |

The index data determined demonstrate that the combination according to the invention of GDA and MIT shows particularly pronounced synergism.

### Example 3

Various concentrations of GDA and MIT and mixtures of the two abovementioned active substances were tested against the bacterium Corynebacterium. The incubation is performed in Landy minimal medium at pH 9 and 26° C. The growth of Corynebacterium was compared at the various active substance concentrations with the growth without active substance. The lowest concentration at which growth was no longer detected is stated as the minimum inhibitory concentration (MIC).

| Active | | MIC | |
|---|---|---|---|
| substance | Mixing ratio | [ppm] | SI |
| GDA | | 10 | |
| GDA:MIT | 1:1 | 5 | 0.75 |
| | (for comparison) | | |
| GDA:MIT | 3:2 | 5 | 0.70 |
| GDA:MIT | 4:1 | 5 | 0.60 |
| GDA:MIT | 16:1 | 5 | 0.59 |
| MIT | | 5 | |

The index data determined demonstrate that the combination according to the invention of GDA and MIT shows particularly pronounced synergism.

### Example 4

Various concentrations of GDA and MIT and mixtures of the two abovementioned active substances were tested against the yeast Rhodotorula rubra. The incubation is performed in malt extract liquid medium at 26° C. The growth of Rhodotorula rubra was compared at the various active substance concentrations with the growth without active substance. The lowest concentration at which growth was no longer detected is stated as the minimum inhibitory concentration (MIC).

| Active | | | |
|---|---|---|---|
| substance | Mixing ratio | MIC [ppm] | SI |
| GDA | | 100 | |
| GDA:MIT | 1:1 (for comparison) | 50 | 0.75 |
| GDA:MIT | 3:2 | 50 | 0.70 |
| GDA:MIT | 4:1 | 50 | 0.60 |
| MIT | | 50 | |

The index data determined demonstrate that the combination according to the invention of GDA and MIT shows particularly pronounced synergism.

### II Chemical Examples

### Example 5

78 g of distilled water, 4.77 g of Kordek 573F (comprises 50% methylisothiazolinone) and 76.9 g of Preventol GDA 50 (comprises 50% glutardialdehyde) were mixed with each other, stored at 40° C. and examined analytically after 1 and 2 months.

### Example 6

76.9 g of distilled water, 3.58 g of Kordek 573F (comprises 50% methylisothiazolinone) and 81.50 g of Preventol GDA 50 (comprises 50% glutardialdehyde) and 18.0 g of bronopol were mixed with each other, stored at 40° C. and examined analytically after 1 and 2 months.

### Example 7

76.9 g of distilled water, 5.37 g of Kordek 573F (comprises 50% methylisothiazolinone) and 79.72 g of Preventol GDA 50 (comprises 50% glutardialdehyde) and 18.0 g of bronopol were mixed with each other, stored at 40° C. and examined analytically after 1 and 2 months.

### Example 8

76.9 g of distilled water, 7.16 g of Kordek 573F (comprises 50% methylisothiazolinone) and 78.0 g of Preventol GDA 50 (comprises 50% glutardialdehyde) and 18.0 g of bronopol were mixed with each other, stored at 40° C. and examined analytically after 1 and 2 months.

### Comparative Experiment

76.9 g of preventol gda 50 (comprises 50% glutardialdehyde), 10.8 g of kathon 39 FG (comprises 24.3% of a salt-free mixture of chloromethylisothiazolinone and methylisothiazolinone) and 72.3 g of water were mixed with each other, stored at 40° C. and examined analytically after 1 and 2 months stated times.

| | Example 5 | | | | Comparative experiment | | | |
|---|---|---|---|---|---|---|---|---|
| | GDA | CMIT | MIT | | GDA | CMIT | MIT | |
| | [%] | [%] | [%] | Appearance | [%] | [%] | [%] | Appearance |
| Beginning | 22.1 | — | 1.33 | Colorless | 23.2 | 1.08% | 0.36 | Colorless |
| | | | | solution | | | | solution |
| 1 m | 22.3 | — | 1.41 | Colorless | 16.4 | 0.001 | 0.32 | Orange |
| | | | | solution | | | | solution |
| 2 m | 22.1 | — | 1.33 | Pale yellow | 6.75 | 0.000 | 0.29 | Brown |
| | | | | solution | | | | solution |
| | | | | | | | | with solid |

| | Example 6 | | | | Example 7 | | | |
|---|---|---|---|---|---|---|---|---|
| | GDA | MIT | Bronopol | | GDA | MIT | Bronopol | |
| | [%] | [%] | [%] | Appearance | [%] | [%] | [%] | Appearance |
| Beginning | 21.7 | 0.97 | 9.96 | Pale beige | 21.6 | 1.52 | 10.11 | Pale beige |
| | | | | solution | | | | solution |
| 1 m | 21.7 | 0.97 | 10.07 | Yellow | 20.4 | 1.49 | 9.68 | Yellow |
| | | | | solution | | | | solution |

| | Example 8 | | | |
|---|---|---|---|---|
| | GDA | MIT | Bronopol | |
| | [%] | [%] | [%] | Appearance |
| Beginning | 21.2 | 2.02 | 10.14 | Pale beige |
| | | | | solution |
| 1 m | 20.6 | 2.02 | 9.77 | Yellow solution |

We claim:

1. A composition comprising glutardialdehyde (GDA), 2-methyl-2H-isothiazol-3-one (MIT) and, if appropriate, 5-chloro-2-methyl-4-isothiazolin-3-one (CMIT) where the CMIT content is from 0 to 4% based on the weight ratio of CMIT to MIT and the weight ratio of GDA to MIT is at least 1.1:1.

2. The composition as claimed in claim 1, characterized in that it comprises, as further component, one or more active substances which are selected from the following group:
bronopol, benzoisothiazolin-3-one, benzyl hemiformal, tetramethylolacetylenediurea (TMAD), 1,3-bis(hydroxymethyl)-5,5-dimethylimidazolidine-2,4-dione (DMDMH), p-chloro-m-cresol, dimethylolurea-1,2-dibromo-2,4-dicyanobutane, 2,2-dibromo-3-nitrilopropionamide, ethylene glycol hemiformal, ethylene glycol bishemiformal, N-methylolurea, 2-phenoxyethanol, phenoxypropanol, o-phenylphenol, chlorophene, quaternary ammonium salts such as, for example, N-alkyl-N,N-dimethylbenzylammonium chloride, and trimethylene-2-methylisothiazolinon-3-one.

3. The composition as claimed in claim 1 or 2, characterized in that it comprises, as further component, one or more fungicides.

4. The composition as claimed in any of claims 1 to 3, characterized in that it comprises 1 to 80% by weight based on the total of GDA and MIT.

5. The composition as claimed in any of claims 1 to 4, characterized in that it comprises, as further component, polyhydric alcohols.

6. A method of protecting industrial materials, characterized in that the industrial materials are treated with a composition as claimed in any of claims 1 to 5.

7. The method as claimed in claim 6, characterized in that it the industrial materials are:
paints, colors, renders and other coating materials
starch solutions and starch slurries or other starch-based products
slurries of pigments or inorganic fillers and pigments
products of construction chemistry, such as concrete additives,
glues or adhesives based on the known animal, vegetable or synthetic raw materials
polymer dispersions based on polyacrylate, polystyrene acrylate, styrene butadiene, polyvinyl acetate
detergents and cleaners for industrial and domestic purposes
mineral oils and mineral oil products
cooling lubricants for metal working based on mineral-oil-comprising, semisynthetic or synthetic concentrates
adjuvants for the leather, textile or photochemical industry
precursors and intermediates of the chemical industry
inks or various types of tusche
wax and clay emulsions.

8. An industrial material, treated with a composition as claimed in any of claims 1 to 5.

9. The use of GDA and MIT for the preparation of compositions as claimed in any of claims 1 to 5.

10. The use of compositions as claimed in any of claims 1 to 5 as preservatives for industrial materials.

11. A method of controlling bacteria, yeasts, slime organisms and molds, characterized in that the bacteria, yeasts, slime organisms and molds are brought into contact with a composition as claimed in any of claims 1 to 5.

12. The method as claimed in claim 11, characterized in that the bacteria, yeasts, slime organisms and fungi are: Alternaria, Aspergillus, Chaetomium, Fusarium, Lentinus, Penicillium, Alcaligenes, Bacillus, Escherichia, Pseudomonas, Staphylococcus, Candida, Geotrichum or Rhodotorula.
